(19) United States
(12) Patent Application Publication
(10) Pub. No.: US 2025/0070692 A1
(43) Pub. Date: Feb. 27, 2025

(54) MULTI-MOTOR INVERTER FOR A PLURALITY OF MOTORS AND DETECTION METHODS FOR DETECTING SHIFTS IN THE SPEEDS OF THE MOTORS

(71) Applicant: ebm-papst Mulfingen GmbH & Co. KG, Mulfingen (DE)

(72) Inventors: Sebastian SCHROTH, Kupferzell (DE); Benedikt STOLL, Elztal-Neckarburken (DE)

(21) Appl. No.: 18/809,728

(22) Filed: Aug. 20, 2024

(30) Foreign Application Priority Data
Aug. 21, 2023 (DE) 10 2023 122 262.7

(51) Int. Cl. H02P 6/04; H02P 6/24

(52) U.S. Cl. CPC H02P 6/04; H02P 6/24; H02P 2006/045

(57) ABSTRACT

The invention relates to a control system (1) comprising a multi-motor inverter (PWR) for the controlled parallel operation of a number of n EC motors (M1, . . . , Mn) whose respective rotor position is detected sensorlessly and controlled by the common inverter.

The invention relates to a method and to a sensorless multi-motor inverter for parallel operation of at least two, in particular a plurality of motors, as well as to a control method for operating the two or more motors on a common multi-motor inverter, in particular with the ability to detect and control the rotor positions or shifts in the speeds of the motors.

For sensorless, more particularly rotor-position-sensor-free operation of an electrically commutated motor (PMSM/EC motor) on an inverter, the voltages applied to the terminals of the motor and the currents flowing in the motor phases are usually recorded and evaluated in a suitable manner in order to determine the rotor position and commutate the motor accordingly. However, no satisfactory solution is known from the prior art for operating two or more such motors (PMSM/EC motor) on a single inverter. When motors are mentioned in the following description, sensorlessly controlled PMSM motors or sensorlessly controlled EC motors are meant.

A motor drive device for two motors is known from printed publication KR 101 687 556 B1. According to one embodiment of that document, the motor drive device comprises an inverter having a number of suitable switching elements and supplies alternating current to a first motor and a second motor by converting direct current into alternating current by switching the switching elements, and a control unit which controls the inverter. The control unit sets a magnetic flux current setpoint according to a speed difference or a phase difference of the first motor and the second motor and controls the inverter on the basis of a switching control signal based on the magnetic flux current setpoint that is set. Accordingly, a speed error can be reduced if a plurality of motors connected in parallel are controlled simultaneously.

DE 10 2018 124 209 A1 describes another design of the present applicant's. The system works with three current measurements per motor. These are used to implement one observer per machine and thus determine the speed and angle of rotation of the respective system. In addition, a reference coordinate system (KOS) is defined, and the control system operates on that basis. This can be one of the two motor KOSs or the inverter KOS, which is calculated based on the residual currents of the motors. To determine this KOS, an additional (third) observer is required. If the system is now fully determined by the observers, a control system including a stabilization controller can be set up which applies a d-current component on the basis of the speed and angle information of the individual motors. In order to avoid repetition of individual structural building blocks and components, it is noted that a person skilled in the art is already familiar with this information from that cited publication. One basic idea of the design described therein is that, in order to operate a plurality of, at least two, electrically commutated motors in parallel on a common inverter without the need for a rotor position sensor, the phase currents are recorded separately for each of the connected motors. In addition, however, only a single voltage measurement is required per inverter output phase, since the parallel operation of the motors means that the same terminal voltage is applied to all motors. Alternatively, it is also conceivable for the terminal voltage not to be recorded, but rather calculated from the control levels outputted by the controller. One substantial difference between the multi-motor inverter disclosed therein and a conventional inverter is the acquisition and processing of the measurement signals for the determination of the rotor position of a plurality of motors, with a separate current acquisition being carried out for this purpose for each motor connected to the multi-motor inverter.

The invention is based on the following starting point. An inverter has a current detection circuit at the output which can detect the current flowing from the inverter into a system of multiple motors. Using methods that are known from the literature, the rotor position of the entire system is then recorded for the system consisting of multiple motors (preferably PMSM). This is not necessarily identical to the individual rotor positions of the motors in the overall system. Furthermore, nothing can be inferred about the status of an individual motor at this time.

To regulate the speed or torque of such an overall system, a well-known field-oriented FOC control method can be used, for example. The high complexity of the FOC requires a programmable building block that can efficiently handle the vector mathematics of the Clarke and Park transformations on which the FOC is based.

For example, a method for operating a plurality of motors on a common inverter as described in DE 10 2018 124 209 A1 can also be used. The current detection that is required for all motor phases and the corresponding number of observers required are disadvantageous. It is true that, in principle, these can be reduced by utilizing the inverter output current. However, this results in pendulum movements between the motors that cannot be detected by the inverter and the overall system, which must also be considered a disadvantage. Furthermore, it must be ensured that each motor operates at a safe operating point.

One key difference of the multi-motor inverter according to the invention is that a detection device or detection method is added which offers the possibility of detecting the rotor position of individual motors within the overall system and adjusting it accordingly.

It is therefore an object of the present invention to provide an improved solution for operating a plurality of motors on one inverter which can be implemented cost-effectively and used as universally as possible and in which the speed shift of two motors is controlled in the case of rotor-position-sensor-free parallel operation of a plurality of, at least two, electrically commutated motors (PMSM/EC motor) on a common inverter using the smallest possible number of current sensors with low computing power.

The object of the invention is achieved according to the features of claim 1.

One basic idea of the invention is to measure the phase current for the corresponding motor by means of (at least) one additional current detection device or circuit, thereby eliminating the observers that would otherwise be required. Based on the information about the current, oscillations as well as the state of a system consisting of a plurality of motors can be detected and then regulated accordingly by a stabilization controller.

Certain parts of the control system are described in detail in DE 10 2018 124 209 A1 and explained using a block diagram and a concrete exemplary embodiment, so that a detailed description can be omitted here. A control system comprising a multi-motor inverter (PWR) for the controlled parallel operation of a number of n EC motors (M1, . . . , Mn) whose respective rotor position is detected sensorlessly is already known from DE 10 2018 124 209 A1.

According to the invention, the following two approaches are provided as preferred solutions for detecting the shift in rotor position. Either the detection of the system vibration (oscillation of the motors) based on the information about the phase current by means of dq transformation and, alternatively, based on direct rotor-position-dependent current sampling.

In the first variant, control is carried out with a sensorless rotor position determination (RLU), the angle of the rotor position determination RLU being used as the reference coordinate system. The target rotation frequency is specified by a fixed setpoint ω_{target}. Then, based on the difference between the speed setpoint ω_{target} and the speed of the sensorless rotor position determination ω_{U}, the speed controller then sets a q-current setpoint I_{q_target}, which results in a voltage control variable U_{q} via the dq-current controller. The d-component of the current I_{d_target} is specified by the stabilization controller on the basis of which the dq-current controller determines the voltage control variable U_{d}. The switching commands are then sent to the inverter via Clarke-Park transformation and a subsequent PWM modulator.

For this purpose, a control system is proposed which comprises a multi-motor inverter (PWR) for the controlled parallel operation of a number of n

EC motors, comprising
a. a stabilization system comprising a stabilization controller,
b. a dq-current controller, to which at least the target current value I_{d,target} is inputted as a controlled variable from the stabilization controller arranged on the input side in space vector representation, on the basis of which the dq-current controller determines the voltage control variable U_{d},
c. wherein at least one or more current detection circuits are provided to measure the phase current of one or more of the n EC motors in order to detect current oscillations and/or oscillations on the basis of the detected information about the current and to regulate the multi-motor system into a stable state via the target current variable I_{d,target} by means of the stabilization controller.

In a preferred embodiment of the two approaches, a speed controller is also provided on the input side of the current controller in order to provide at least the target speed (and possibly other parameters, as shown in the block diagrams in the exemplary embodiments presented below).

In the first embodiment, which uses fundamental wave detection in the current signals, the stabilization system has a transformer to determine the target current value I_{d,target} by means of a Clarke-Park transformation from at least two detected phase currents and the rotor position.

In the alternative solution with rotor-position-dependent current detection, a provision is made that the alternating component of the current signal is recorded in order to determine the oscillations and specified to the current controller, preferably by means of filtering, as the setpoint I_{d,target} in order to impart a greater torque to the lagging motor and a reduced torque to the leading motor in order to thereby reduce the determined oscillation.

A further aspect of the present invention relates, in addition to the described control system, to a method for operating n EC motors, where n≥2, in parallel operation on the common multi-motor inverter (PWR) (for the first embodiment) with at least the following steps:
specifying a target rotation frequency by a fixed speed setpoint ω_{target},
setting a target q-current q_target based on the difference between speed setpoint ω_{target} and the speed of the sensorless rotor position determination ω_{U}, a voltage control variable U_{q} being generated by the dq-current controller from the target q-current I_{q_target},
detecting at least one, preferably a plurality of phase currents (I_{M1,u}, I_{M2,v}, . . . ) with a separate current detection device, the stabilization system determining the target current value I_{d,target} by means of Clarke-Park transformation from at least two detected phase currents (I_{M1,u}, I_{M2,v}, . . . ) and the rotor position,
feeding the transformed values of the fundamental wave detection F for further processing;
determining the voltage control variable U_{d} based on the d-target current value I_{d_target} in order to transform them using Clarke-Park transformation and then to send them via a PWM modulator as switching commands to the multi-motor inverter (PWR) for the controlled parallel operation of the EC motors (M1, . . . , Mn).

In the second embodiment, simultaneous or nearly simultaneous, rotor-position-dependent measurement of the phase currents at the multi-motor inverter (PWR) or at the motor(s) is carried out at certain mechanical and/or electrical angles of the estimated rotor position of the multi-motor system with the following additional steps:
determining whether there is oscillation of the motors in the multi-motor system by analyzing the current signals for their AC component, and if so,
stabilizing the motors by issuing appropriate switching commands to the multi-motor inverter (PWR) or setting the output voltages to the motors in order to counteract or eliminate the oscillation.

Preferably, a provision is made that, in the event of a load jump during operation of the multiple motors, the filtered oscillation term is also switched on in order to compensate for the oscillation (in the transformed design variant).

The current measurement for recording the phase currents should preferably be carried out directly on the motors.

Other advantageous refinements of the invention are characterized in the subclaims and/or depicted in greater detail below together with the description of the preferred embodiment of the invention with reference to the figures.

### BRIEF DESCRIPTION OF THE DRAWINGS

FIG. 1 is a block diagram of a known method for controlling a multi-motor controller, but supplemented with a modified stabilization controller;

FIG. 2 is a block diagram of a stabilization controller for use in the multi-motor controller that has been modified according to the invention; and

FIG. 3 is a block diagram of an alternative stabilization controller for use with the multi-motor controller that has been modified according to the invention.

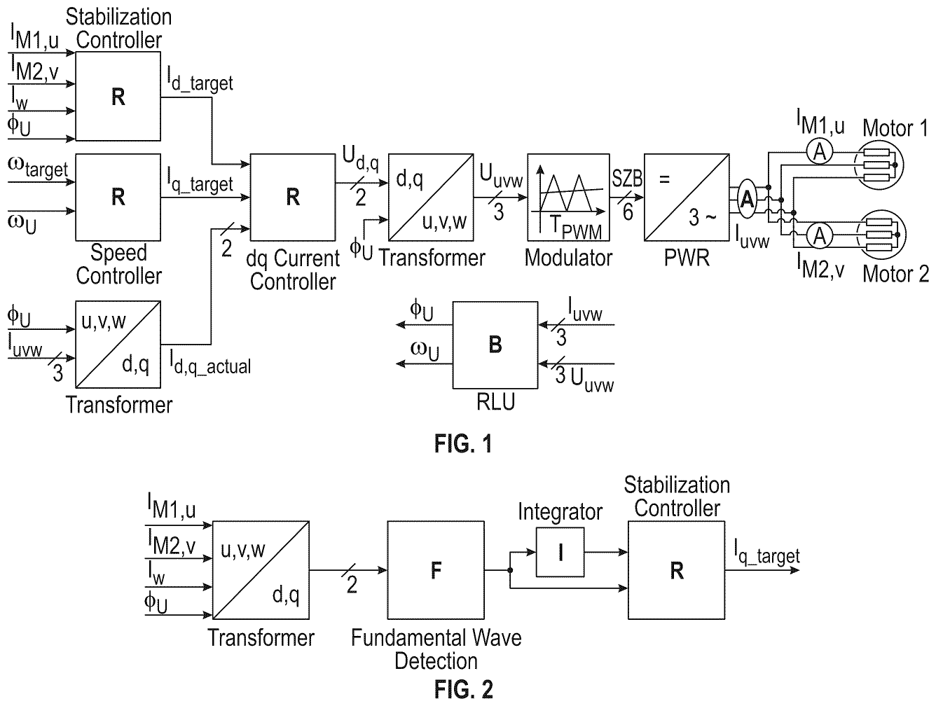

The invention will be explained in greater detail below on the basis of the embodiments with reference to FIGS. 1 to 3, with same reference symbols in the figures indicating same structural and/or functional features.

FIG. 1 shows a control system 1 comprising a multi-motor inverter PWR for the controlled parallel operation of a number of two EC motors M1 (motor 1), M2, (motor 2).

For this purpose, a detection device RLU is provided for determining at least the rotor position and speed of a fictitious motor at the inverter output using the previously measured phase currents or the residual current I_{u,v,w} and the terminal voltage U_{u,v,w} of the two EC motors. The detection device RLU is thus particularly designed to obtain the rotor position φ_{U}, the residual current I_{uvw} being used as an input variable and the terminal voltage U_{uvw} also being used to determine the variables of rotor position φ_{U} and speed ω_{U}.

In both embodiments, a control device is provided downstream of the control and transformation device, to which the voltage variables U_{d}, U_{q} and current variables I_{d,q_actual} outputted by the transformation device are fed in order to generate switching commands SZB for the multi-motor inverter PWR in order to operate the two motors.

The control and transformation device has a Clarke-Park transformer TP for transforming the rotor position φ_{U} and residual current I_{uvw} into a dq current value I_{d,q_actual} in space vector representation for the control device.

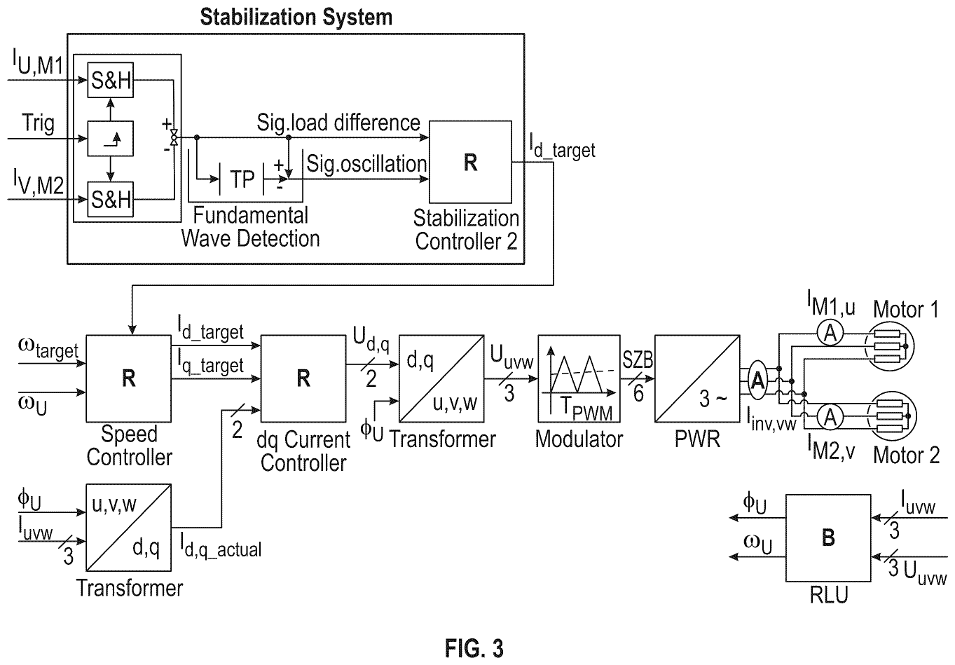

The two embodiments can be represented equally by FIG. 1, since the difference lies in the stabilization controller R_{S} (see FIGS. 2 and 3).

FIG. 2 shows a block diagram of a first embodiment of a stabilization system with a stabilization controller RS for use with the multi-motor controller PWR that has been modified according to the invention.

After the transformation of the input variables shown, including the phase currents used for the two motors M1, M2, these are fed to the fundamental wave detection F and further processed (using conventional mathematical algorithms and methods, which will therefore not be described in further detail). The stabilization controller R_{S} makes the current variable I_{d_target} available.

FIG. 3 shows an alternative stabilization solution which determines the delta between the measured motor phases and, on that basis, determines the target value of the d-current. The sample & hold blocks sample the current values and then calculate the difference. This difference is then passed directly to the stabilization controller R_{S}. In addition, the oscillation frequency of the motors is filtered out by the fundamental wave detection (TP) and made available to the stabilization controller R_{S}.

Here too, the stabilization controller R_{S} makes the current variable I_{d_target} available. However, current sampling takes place here. The processing is shown in the block diagram.

In the variant currently being presented, the number of observers required has been reduced to just one observer. This is possible because only the information on the vibration of the mechanical subcomponents needs to be known in order to stabilize the system. The implementation now being presented determines this information directly from the current without requiring multiple measuring points and observers.

In order to implement the first design variant, only measuring points on the residual current and on a total of two different phases of the two motors are required. An observer for the inverter KOS can be implemented based on the residual current measurement. Based on the other two measurements in combination with the residual current measurement, the vibration component of the motors can be determined on the basis of a simple Clarke-Park transformation. This serves as basic information for the setpoint of the d-current controller.

The second design variant utilizes the difference in current between two identical motor phases to determine the oscillation term. This means that no Clarke-Park transformation is necessary, but a current measurement in two identical motor phases is required. Please note that measurements do not necessarily have to be taken in the same phases. In the case of different phases, however, mathematical processing of the data (e.g., buffering, synchronization) must be used to ensure that, for example, the max./min. or the signals of a phase offset by 60/120° are always compared.

The invention is not limited in its execution to the abovementioned preferred exemplary embodiments. Rather, a number of variants are conceivable which make use of the illustrated solution even in the form of fundamentally different embodiments.

1. A control system (1) comprising a multi-motor inverter (PWR) for the controlled parallel operation of a number of n EC motors (M1, . . . , Mn), where n≥2, comprising
a. a stabilization system comprising a stabilization controller (R_{S}),
b. a dq-current controller, to which at least the target current value I_{d,target} is inputted as a controlled variable from the stabilization controller (R_{S}) arranged on the input side in space vector representation, on the basis of which the dq-current controller determines the voltage control variable U_{d},
c. wherein at least one or more current detection circuits are provided to measure the phase current of one or more of the n EC motors (M1, . . . , Mn) in order to detect current oscillations and/or oscillations on the basis of the detected information about the current and to regulate the multi-motor system into a stable state via the target current variable I_{d,target} by means of the stabilization controller (R_{S}).

2. The control system (1) according to claim 1, characterized in that a speed controller (RD) is provided on the input side of the current controller in order to provide at least the target speed.

3. The control system (1) according to claim 1, characterized in that the stabilization system has a transformer in order to determine the target current value I_{d,target} from at least two detected phase currents (I_{M1,u}, I_{M2,v}, . . . ) and the rotor position by means of a Clarke-Park transformation.

4. The control system (1) according to claim 1, characterized in that the alternating component of the current signal is recorded in order to determine the oscillations and specified to the current controller, preferably by means of appropriate fundamental wave detection or filtering and amplification, as the setpoint I_{d,target} in order to impart a greater torque to the lagging motor and a reduced torque to the leading motor in order to thereby reduce the determined oscillation.

5. A method for operating n EC motors, where n≥2, in parallel operation on a common multi-motor inverter (PWR) with a control system (1) according to claim 3, with at least the following steps:
d. specifying a target rotation frequency by a fixed speed setpoint ω_{target},
e. setting a target q-current I_{q_target} based on the difference between speed setpoint ω_{target} and the speed of the sensorless rotor position determination ω_{U}, a voltage control variable U_{q} being generated by the dq-current controller from the target q-current I_{q_target},
f. detecting at least one, preferably a plurality of phase currents (I_{M1,u}, I_{M2,v}, . . . ) with a separate current detection device, the stabilization system determining the target current value I_{d,target} by means of Clarke-Park transformation from at least two detected phase currents (I_{M1,u}, I_{M2,v}, . . . ) and the rotor position,
g. determining the voltage control variable U_{d} based on the d-target current value I_{d_target} in order to transform them using Clarke-Park transformation and then to send them via a PWM modulator as switching commands to the multi-motor inverter (PWR) for the controlled parallel operation of the EC motors (M1, . . . , Mn).

6. A method for operating n EC motors, where n≥2, in parallel operation on a common multi-motor inverter (PWR) with a control system (1) according to claim 4, with at least the following steps:
h. simultaneous or nearly simultaneous, rotor-position-dependent measurement of the phase currents at the multi-motor inverter (PWR) or at the motor(s) is carried out at certain mechanical and/or electrical angles of the estimated rotor position of the multi-motor system;
i. determining whether there is oscillation of the motors in the multi-motor system by analyzing the current signals for their AC component, and if so,
j. stabilizing the motors by issuing appropriate switching commands to the multi-motor inverter (PWR) or setting the output voltages to the motors in order to counteract or eliminate the oscillation.

7. The method according to claim 6, wherein in the event of a load jump during operation of the plurality of motors, an extracted oscillation frequency is used to compensate for the oscillation and to stabilize the system.

8. The method according to claim 1, wherein the current detection provides at least one measurement on the motor phase of a motor and, additionally, either a residual current measurement or a further current measurement on another motor.

9. The method according to claim 1, wherein the current detection is performed directly on the motors.

10. The method according to claim 1, wherein a shutdown can occur upon detection of a phase failure.
